(19) United States
(12) Patent Application Publication
(10) Pub. No.: US 2015/0077737 A1
(43) Pub. Date: Mar. 19, 2015

(54) SYSTEM AND METHODS FOR MONITORING AN ENVIRONMENT

(71) Applicant: cnry Inc., Brooklyn, NY (US)

(72) Inventors: Mark Belinsky, Brooklyn, NY (US); Justin Alvey, San Francisco, CA (US)

(21) Appl. No.: 14/455,759

(22) Filed: Aug. 8, 2014

Related U.S. Application Data
(60) Provisional application No. 61/863,990, filed on Aug. 9, 2013.

(51) Int. Cl. G01N 21/49; G08B 17/103; G08B 17/107; G01N 21/53

(52) U.S. Cl. CPC G01N 21/49; G01N 21/53; G08B 17/103; G08B 17/107
USPC 356/51; 356/343; 250/208.2

(57) ABSTRACT

The device described herein monitors air quality continuously using a plurality of sensors. The device continuously records the sensor measurements and makes the measurements available to a user though a server based platform. The device further analyzes the sensor data to detect hazards and uses the plurality of sensor measurements to further characterize the hazards and to decrease instances of false alarms.

### CROSS-REFERENCE

This application claims the benefit of U.S. Provisional Application No. 61/863,990, filed Aug. 9, 2013, which application is incorporated herein by reference.

### BACKGROUND

Homes and buildings experience fluctuations in temperature, air constituents, and occupancy. Fluctuations in these variables may indicate a dangerous event that may be important to relay to an occupant. Furthermore, monitoring these fluctuations may inform an occupant about expected or typical conditions in a home or building environment.

### SUMMARY

A need exists for continuous for home air quality monitoring both for detection of hazards such as fires, natural disasters, chemical spills, and invasions as well as for daily health monitoring. A device capable of monitoring both hazards and baseline air quality measurements is described herein. The device is capable of distinguishing between a real hazard and a false alarm using a plurality of sensors in unison. The device may learn over time as it reacts to various hazards. The device discussed herein is further in communication with an off board server to contact service organizations in the case of a hazard and to alert a community of users in the event of a detected hazard. Furthermore the device conducts continuous air monitoring and provides a user with time history data of the air quality measurements.

In an embodiment, the environmental detector may comprise a particle detector, wherein the particle detector may comprise a first light source and a second light source, a first photodetector and a second photodetector. The first photodetector and the second photodetector may be configured to sense light scattered from a particle at a first scattering angle and a second scattering angle and on or more sensors configured to monitor an environmental condition.

In some cases the first light source may emit light with a wavelength in the range of 400 nm to 500 nm. The second light source may emit light with a wavelength in the range of 800 nm to 1 μm. In some embodiments the first scattering angle and the second scattering angle may be different. The particle detector may be configured to detect smoke, dust, pollen, soot, water vapor, and particulate matter with a diameter below 10 micrometers.

In another embodiment, the environmental detector may comprise a plurality of sensors configured to monitor a concentration of species in an air space in the environment, wherein the plurality of sensors generate a continuous data stream comprising measurements of the concentrations of the species in the air space at discrete time intervals. The environmental detector may further comprise a memory unit configured to store the data stream generated by the sensors, a processor configured to interpret the data stream to characterize the air space, and further configured to initiate an audio or visual response to the characterization of the air space, and a transceiver configured to communicate with one or more electronic devices and a server off board the environmental detector, wherein the transceiver is further configured to communicate the air space characterization to the electronic devices and/or to the server at a discrete interval, wherein a user may confirm or denies the air space characterization through the electronic device.

In some instances, the species may be gaseous species and/or particles. The characterization of the air space may comprise a detection of a hazardous event, a change in air quality condition, and/or a security breach. The electronic device may be a laptop, desktop, smart watch, smart glasses, tablet, or smartphone. The discrete time interval may be in the range of 0.01 milliseconds to 24 hours. The audio or visual response to the characterization of the air space may be a colored light. The audio or visual response to the characterization of the air space may be a spoken command. The audio or visual response to the characterization of the air space may be terminated remotely by the electronic device.

In another embodiment, the environmental detector may comprise a plurality of sensors configured to monitor a concentration of species in an air space in the environment, wherein the plurality of sensors generate a continuous data stream comprising measurements of the concentrations of the species in the air space at discrete time intervals. The environmental detector may further comprise a memory unit configured to store the data stream generated by the sensors and a transceiver configured to communicate with one or more electronic devices and a server off board the environmental detector, wherein the transceiver if further configured to communicate the air space characterization to the electronic devices and/or to the server at a discrete interval, wherein the server broadcasts the air space characterization to a group of users within a selected region.

The group of users may be within a geographic radius of the environmental detector. The group of users may not own an environmental detector. The species may be gaseous species and/or particles. The characterization of the air space may comprise a detection of a hazardous event, a change in air quality condition, and/or a security breach. The electronic device may be a laptop, desktop, smart watch, smart glasses, tablet, or smartphone.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 shows a possible embodiment of an environmental detector.

FIG. 2 shows an example of possible functions of an environmental detector.

FIG. 3 shows possible connectivity and components in a communication system associated with an environmental detector.

FIG. 4 shows a graphical interpretation of sensor data that may be displayed on a user interface on a computer device in communication with an environmental detector.

FIG. 5 show a graphical description of the inputs to an air quality assessment by an environmental detector.

FIG. 6 shows a graphical description of the inputs to a security assessment by an environmental detector.

FIG. 7 shows an example of how CO₂ monitoring by the environmental detector can distinguish between CO₂ emissions of two different animal species.

FIG. 8 shows a graphical description of the inputs to a hazard detection by an environmental detector.

FIG. 9 shows an exploded view of the components of an environmental detector.

FIG. 10 shows a detailed view of an embodiment of a particle detector

FIG. 11 shows a schematic of an example of a community response to a hazard detected by the environmental detector.

FIG. 12 shows a schematic of an example of overall connectivity of an environmental detector.

FIG. 13 shows an example of a geographic radius including users that may and not be notified of an alarm.

FIG. 14 shows an example of flow chart describing data collection and graph generation.

FIGS. 15 a-b show an example of an environmental detector in which the entire outer housing may be a pressable button.

FIG. 16 A shows an example of a front view of a particle detection sensor housing.

FIG. 16 B shows an example of a side view of a particle detection sensor housing.

FIG. 16 C shows an example of an under side view of a particle detection sensor housing.

FIG. 17 shows a detailed view of an example of baffles on a particle detection sensor housing.

FIG. 18 shows an example of a cross-sectional view of a particle detection sensor housing.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

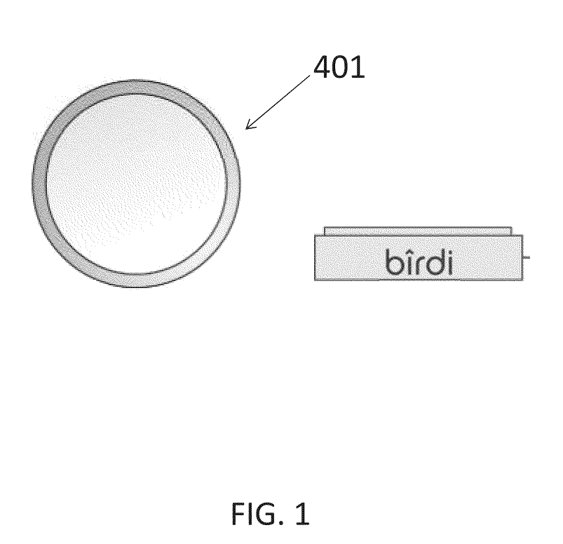

FIG. 1 shows an environmental detector 101. An environmental detector, such as the detector described in FIG. 1, may be installed in a space to be monitored. A space may be, for example, a home, apartment, a room, an interior of a vehicle, boat, airplane, yurt, shipping container, house, group of houses, or a building. An environmental detector may comprise a variety of sensors configured to monitor composition of the air surrounding the detector. The environmental detector may further comprise audio, vision, pressure, temperature, humidity, location (e.g. GPS), motion, inertial (e.g. accelerometer, magnetometer, or gyroscopic), organism, light, and/or Bluetooth sensors. A temperature and humidity sensor may be a combined sensor. The sensors may be stored entirely in the environmental detector 101. Additionally the environmental detector may communicate with sensors off board the environmental detector. The environmental detector 101 may have openings to allow ambient air into the detector 101 for gas composition measurements. The environmental detector 101 may be configured to fit easily into a user's hand for easy installation and removal from a wall or ceiling for charging or changing batteries. The device may be further configured to provide a home hub for broadcasting media, boosting cell phone reception, and/or repeating WiFi or other RF signals. The device may be configured to alert a user when a WiFi signal has failed or gone out.

An environmental detector may have similar dimensions to a typical smoke detector such that the environmental detector may fit into the footprint of a typical smoke detector, a typical smoke detector may have a longest dimension of 4 inches and a thickness of 2 inches. Alternatively, a typical smoke detector may refer to any gas or air sensing device installed in a home residence. The environmental detector may be circular. The environmental detector may be square, rectangular, oval, or any other regular or irregular shape. The environmental detector may have a longest dimension of at least 50 mm, 60 mm, 70 mm, 80 mm, 90 mm, 100 mm, 110 mm, 120 mm, 130 mm, 140 mm, 150 mm, 160 mm, 170 mm, 180 mm, 190 mm, or 200 mm. The Environmental detector may have a thickness of at least 10 mm, 20 mm, 30 mm, 40 mm, 50 mm, 60 mm, 70 mm, or 80 mm. In a preferred embodiment the environmental detector may be circular with a diameter of roughly 130 mm and a thickness of roughly 40 mm. The environmental detector may be configured to be mounted on a wall or ceiling of a building or a room in a building.

The environmental detector may collect, store, analyze, and broadcast sensor data pertaining to the air composition of an environment in which a detector may be installed. The sensor data may characterize the air space surrounding the environmental detector. The detector may continuously monitor air composition in the environment. Continuously monitoring may be monitoring of air composition regardless of an alert condition, for example, the device may monitor air composition during conditions in which the air quality is good as well as when the air quality is bad or is indicative of a hazard. The environmental detector may transmit air compositions measurements to a server off board the environmental detector.

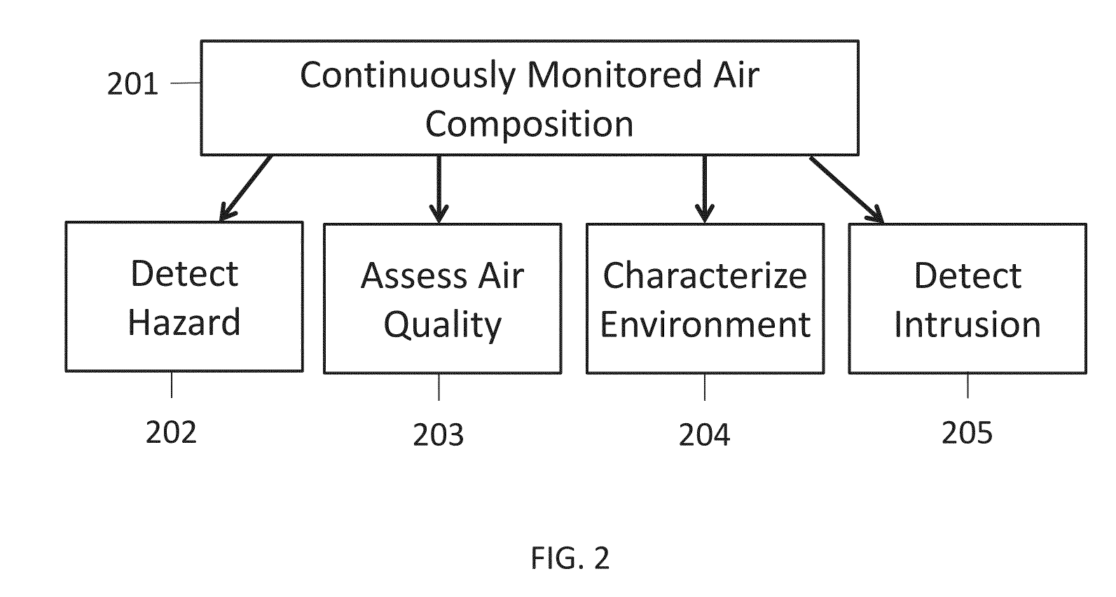

FIG. 2 shows how the data obtained from continuous air quality monitoring, or characterization, 201 may be applied to detection of events.

The air monitoring data may be used to detect a hazard 202. A hazard may be an event correlating with a sensor measurement that is expected to cause harm to a human and or the building structure in an environment surrounding the detector. A hazard detection may result in a warning state followed by an alarm state. A warning state may comprise a notification to a user or a group of users to confirm or deny a potential detected hazard. An alarm state may occur after a user or group of users has confirmed that the detected hazard is real (e.g. not a false alarm). In some cases the warning state may be skipped and only an alarm state may occur. For example, a hazard may be a fire, nearby natural disaster, severe weather conditions, or chemical spill. A hazard may otherwise indicate that a sensor measurement has exceeded a pre-set threshold. A pre-set threshold may be set by a user for one or more sensor measurements. A user may choose a pre-set threshold of a sensor value to correspond to conditions which may be hazardous to an environment. For example, an environment which may be more sensitive to a gas or particle species may have a lower threshold value for the gas or particle species than an average environment.

The air monitoring data may be used to assess air quality 203. Air quality measurements may be baseline measurements of the species (gases and particles) detected in an air space in the environment surrounding the detector. A measurement of air quality may indicate that conditions are good, tolerable, or bad for a human or other animal present in the environment. The environmental detector may instruct a user to instigate a behavioral change or to implement a device to correct a negative air quality assessment outcome. In an example, the air monitoring data may be used to determine if ventilation is needed or if a source of adverse air pollution is present in the vicinity of the sensor. In another example, the air monitoring detector may indicate that a product may be needed to improve air quality (e.g. a fan or a filter or plants). If need for a product to improve air quality is detected a user may be sent a notification informing them of where the product can be purchased. The air quality assessment may be used by a medical professional to identify risk factors for respiratory disease in an individual or a population. Additionally, the air quality assessment may be presented to a health insurance agency to indicate a healthy home to justify a decrease on an insurance premium. The air quality assessment may be available for purchase to real-estate agencies or to potential home buyers. The air quality assessment may be used as a factor in pricing a home for sale.

The air quality assessment may inform the environmental detector about expected conditions in an environment 204. Historical air monitoring measurements may be used to determine a base line expected value for each sensor measurement in an environment, deviations from the baseline may indicate a need for alarm. For example, an environmental detector may sense high humidity in a humid climate and may therefore, automatically calibrate a humidity sensor to expect a high threshold level of humidity. Alternatively, a user may inform an environmental detector regarding conditions in a space to be monitored by the detector. In an example, a user may increase a sensitivity of a sensor on board the environmental detector to sense mold particles in a space that has recently been flooded.

Furthermore, the environmental detector may be capable of including a security feature to detect an intrusion of a human or other animal into an environment 205. The environmental detector may recognize humans and other animals by detection of CO₂ emission, particulate emissions, and audio sensing. Additionally, the environmental detector may be configured to detect signals from electronic devices and may be able to distinguish a foreign electronic device from an electronic device belonging to the owner of a detector. The environmental detector may further comprise a passive infrared (PIR) sensor for sensing thermal (heat) footprints and movement of humans and animals. The PIR sensor may be configured to sense thermal disturbances through a housing of the environmental detector.

The sensors on board the environmental detector may generate a data stream comprising measurements of the concentrations of species in an air space surrounding the detector at discrete time intervals. A species may be a gas or particle in the air space surrounding the detector. A concentration may refer to a mass, mole, volume percentage of a species in a gas. Alternatively concentration may be used interchangeably with number density, and light obscuration percentage. The data stream may be generated continuously such that data points may be collected and stored for normal baseline sensor readings as well as for baseline deviations. A continuous collection of a data stream may indicate that a data point is collected and recorded at each pre-set time interval. All data points may be collected and recorded regardless whether a data point corresponds to a baseline condition or an alarm condition. The data stream may be stored temporarily or permanently on a memory storage device on board the environmental detector. The memory storage device may be a non-transitory storage medium such as a hard drive, a CD, a DVD, or a flash memory device. The memory storage device may also store software configured to execute an operating program, in an example the operating program may be executed by the processor. The memory storage device may periodically send data to a device off board the environmental monitoring detector at a fixed time interval, for example the fixed time interval may be every 6 hours. The device off board the environmental detector may be a server, a cloud server, or a computer unit. An asynchronous connection to the server may be made by the memory storage device when the sensors detect an abnormality. An abnormality may be detection of a gas or particle species above a fixed threshold value or detection of a spike in the concentration of a gas or particle species. In addition to or instead of being sent to the storage device the data may be sent to a processor or microprocessor on board the environmental detector. The storage device may be operatively linked to the processor. The processor may be a STM32 32-bit ARM cortex microprocessor. The processor may be configured to interpret the data stream to characterize an air space in the environment surrounding the environmental detector. The processor may further be configured to broadcast the characterization of the air space to one or more devices and/or to a server off board the environmental detection device through a transceiver.

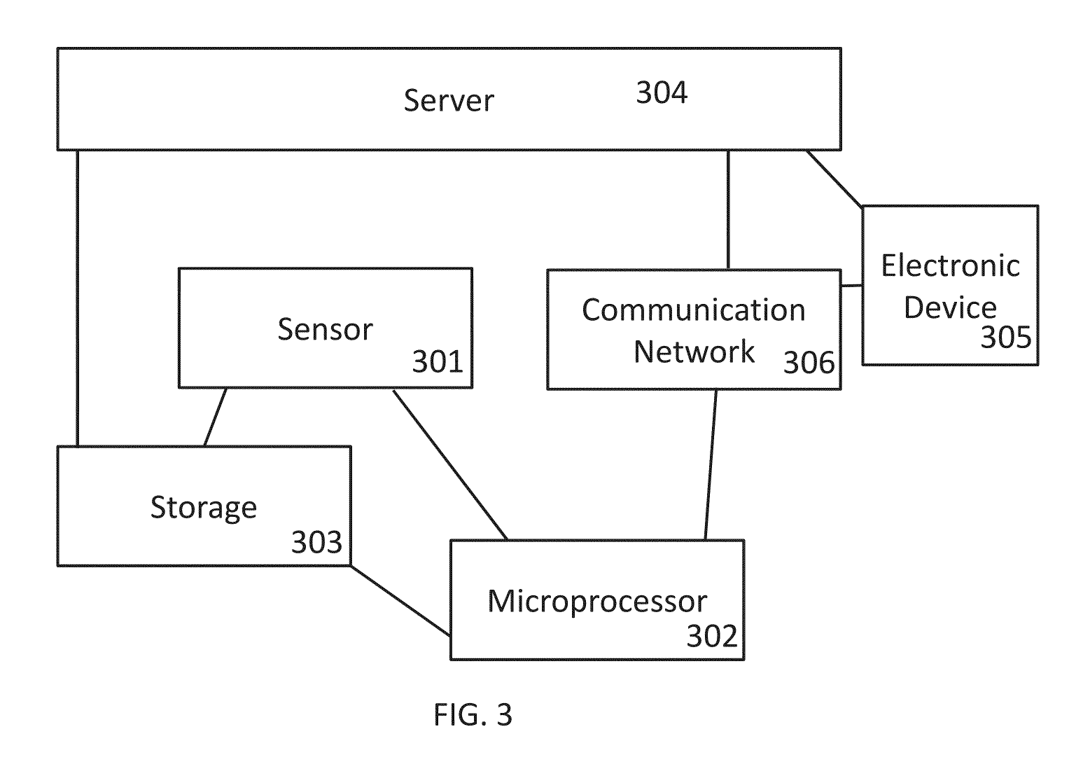

FIG. 3 shows a graphic describing an exemplary system architecture. Sensors 301 may send sensor measurements to a processor 302 on board the environmental detector or to a storage device 303 on board the environmental detector. The storage device 303 may send stored measurements to a processor 302 on board the environmental detector or to a server 304 off board the detector. When a electronic device 305 connected to the environmental detector is in the vicinity of the detector, the processor 302 may communicate with the electronic device directly 305 through a communication network 306. The electronic device 305 may communicate directly with the server 304. In an example the communication network may be a LAN, WAN, cloud, direct 1R, Bluetooth, or RF network. The communication network may be wireless or a wired network. Alternatively, when an electronic device is outside of a region in range of the environmental detector, a user may communicate through the communication network 306 with the environmental detector through a server 304 in communication with the detector. A group of electronic devices may communicate with an environmental detector. The group of electronic devices may contain a designated set of devices belonging to one or more users that have been added by an initial user or those devices of user's that have been permitted by the initial user to opt-in to the system. A second tier of user, concerned parties, may also have devices in connection with the environmental detector either through designation or opt-in. The second tier of users may not be able to control functions of the environmental detector through their electronic devices, rather they may receive only notifications from the environmental detector.

The environmental detector may be in communication with other environmental detectors installed in a space, for example, in a household. In addition to communicating with other environmental detectors, each environmental detector may also communicate with one or more other monitoring devices. The environmental detector may communicate with one or more other home devices wirelessly or through a wired connection. Example of other home devices may include a burglar alarm, motion detector inside or outside of a space, thermostat, humidifier, fingerprint scanner, facial recognition device, fan, lights, or leak detectors. The environmental detector may also be in communication with sensors on board electronic devices, for example a pressure or humidity sensor on a smart phone. The environmental detectors in communication with each other may form a mesh to monitor across a large space and/or many rooms. The environmental detector or a mesh of environmental detectors may be in communication with an electronic device, for example, a smartphone, game system, television, tablet, laptop, desktop, other mobile personal computers, electronic medical devices, and/or wearable technology (e.g. smart watches or smart glasses). Additionally the electronic detector may communicate with a fitness tracker. The environmental detector may increase sensitivity to particulates and adverse gas species when a fitness tracker indicates that a user has an elevated heart rate that may correlate with heavy or deep breathing. The environmental detector may communicate with the listed devices over a suitable network connection. The environmental detector may comprise a transceiver configured to establish a connection to one or more home WiFi networks. The transceiver may be a IEEE 802.11 transceiver for establishing a network connection to connect to one or more home WiFi networks to connect to the internet and local electronic devices. The transceiver may be a CDMA/GSM Chipset transceiver for establishing in cases where cellular reception permits an alternative to the IEEE 802.11 connection, or other network connection, to enable an internet connection for sending data to the online server. The transceiver may be a mobile telecommunications chipset such as CDMA, GSM, 3G, 4G, and/or WiMAX. The transceiver may alternatively be an IEEE 802.15 transceiver (e.g. Bluetooth 15.1) for communicating with other environmental detectors and electronic devices. The detector may be configured to broadcast a unique identifier to be automatically discoverable without user initiating pairing. The environmental detector may communicate with the electronic devices through the established network connection for example a LAN, WAN, cloud, direct 1R, Bluetooth, or RF network. The environmental detector may also communicate with a server off board the environmental detector through the established network connection. Additionally, the environmental detector may access the internet through an established WiFi connection to obtain information about an environment in which the detector is installed in real time. Information about an environment may include local events, weather forecast, seasonal averages for temperature and humidity, traffic patterns, air quality forecasts, UV forecasts, current measured UV intensity, atmospheric pressure, reports of nearby fires, reports of nearby crimes, and/or city planning schedules (e.g. construction schedules, street cleaning) Alternatively information about the environment may come from crowd sourcing. Information about an environment may also include characterization of typical air particulates. Typical air particulates in a specific environment may refer to common pollen sources in an environment, small insects, and types of dust particulates. In an example, different trees and flowers may produce pollen with differing molecular weights and sizes. A device may be aware of the expected pollen characteristics in a location and may use expected characteristics to confirm particles detection events by a particle detector on board the environmental detector. In an example, the environmental detector may access the internet to obtain and/or contribute to a weather report, traffic report, or weather radar map in order to provide additional data to interpret sensor measurements. The transceiver may send an HTTP request over an internet gateway such as a WiFi router, send data to an electronic device, using a protocol such as Bluetooth, and having the device relay data to the server using its own internet connection, send data over a cellular network, and/or relay data to other environmental detectors which may have a better means (e.g. stronger network connection, more battery charge) to send the data to the server.

Alternatively or in addition to a connection between an environmental detector and a smart device, the environmental detector may connect to a land line through a telephony system. The telephony system may use a landline telephone call to initiate communication between a detector user and a detector. A user may be able to call a number to hear a recording of the current or historical air quality conditions over a landline. The number may be a toll free number. Alternatively, a user may “flash”, a technique in which a user calls without the opposite side answering and the opposite may call back with appropriate information.

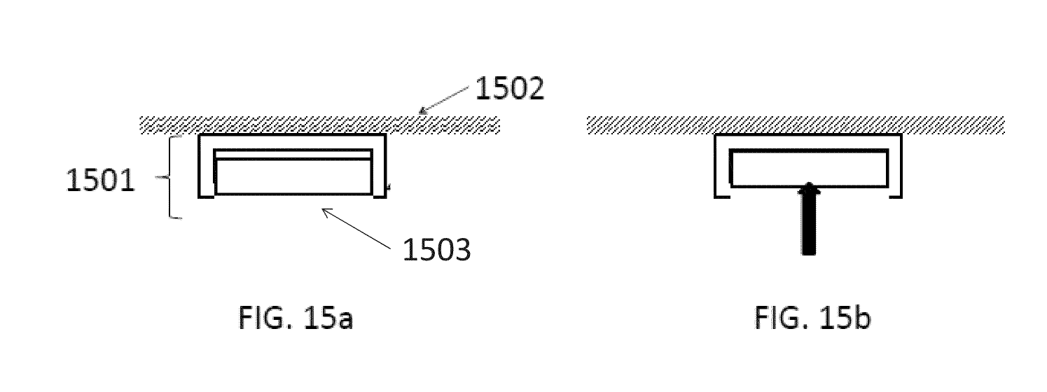

A communication connection between an environmental detector and an electronic device may create an interface for a user to control and exchange information with an environmental detector. The environmental detector may have an external button which may be pressed by a user to mute or test an alarm on the environmental detector. The button may be customized with adhesive stickers or custom button with printed or etched designs. The buttons may be custom ordered. The external button may be pressed to initiate sending monitoring data or an air space characterization to the server. The external button may be an entire external housing. The external housing may comprise a fixed outer ring and a movable inner button. In a case in which the external housing comprises a moveable inner button, the button may be large enough to be accessed without removing the environmental detector from a wall or ceiling. The button may be accessed by throwing an object at the environmental detector or by poking the environmental detector from a distance. In an example, the button may be pressed using a broom handle or another long beam like object. FIG. 15a shows and example of an environmental detector 1501 mounted to a surface 1502 in which the outer housing comprises a movable inner button 1503. In the view shown in FIG. 15a the button is not being pressed. A user may compress the outer housing's inner button 1503 to achieve the state shown in FIG. 15b in which the inner button 1503 has been pushed upward towards the mounting surface 1502. A user may push the button to test a battery, silence an alarm, or program an environmental detector. In some embodiments the environmental detector may be configured to sense the location and duration of pressure applied by a user to the button. For example, the detector may be able to detect a user pressing the button on the center or on a side. Additionally, the detector may be able to detect a user pressing the button on the right, left, top or bottom edge of the detector. Furthermore, the detector may be able to differentiate between a press of the button by a user lasting for less than a specified duration of time or more than a specified duration of time. The specified duration of time may be on the order of a millisecond, a second, 10's of seconds, or a minute. Differences in location and duration of pressure from a user to the button on the environmental detector may cause different responses from the detector. The detector may be pressed in different locations and/or with different durations in a pattern to communicate a specific instruction to the environmental detector.

The environmental detector may have a screen to display visual controls. The visual controls may communicate conditions of the environmental detector, current readings, and may also provide a location for a user to input a command. Alternatively, the environmental detector may not have a screen, button console, adjustment knobs, or any other means by which to be controlled by a used. A user may relay a command to the environmental detector through a gesture on an electronic device in communication with the environmental detector, for example shaking or touching the electronic device. A user may control the environmental detector entirely though a user interface on an electronic device in communication with the environmental detector. A user may transfer profile and internet connection settings to the environmental detector through the user interface. The electronic device may display time of installation and manufacture for the environmental detector. Alternatively, time of installation and manufacture may be written on the detector. Additionally a user may adjust settings on the environmental detector through the electronic device user interface. Examples of settings that may be adjusted may include, frequency of air quality readings, frequency of storage communication with the server, sensor sensitivity, turning sensors on and off, indicating which users can be alerted when a hazard condition is detected, and changing a preferred alert communication channel. The user may dismiss alerts from the environmental detector and temporarily disable a visual or audio alarm on the environmental detector from the electronic device or partner device (e.g. phones, glasses, watches, or television). Alerts may be dismissed by shaking the electronic device, speaking to the electronic device, pushing a button, or touching a screen of an electronic device. The user interface may also display graphical data, raw data, point data, or a table of data with historical or real time sensor data from the environmental detector.

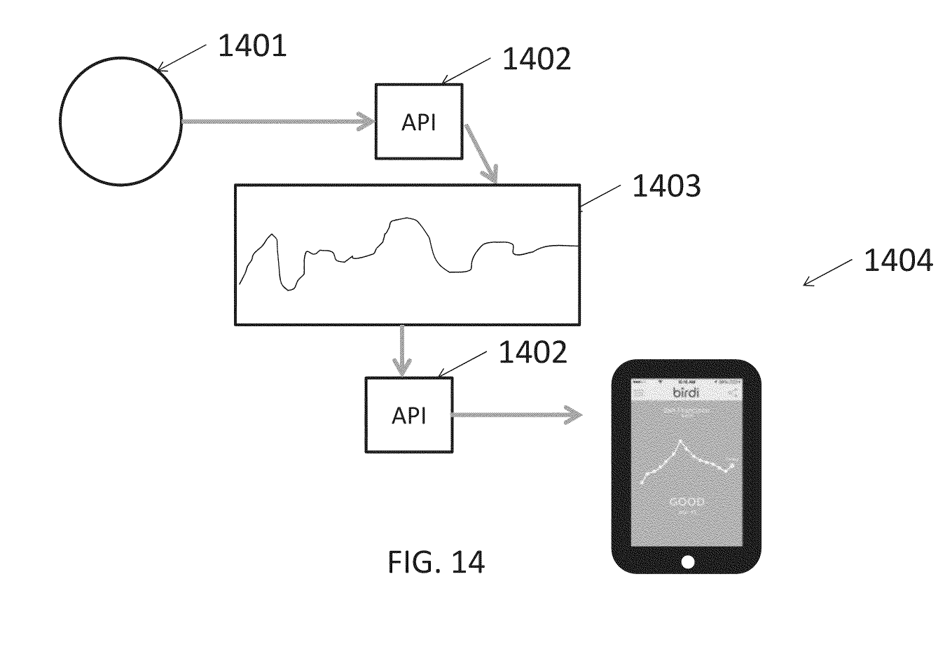

FIG. 14 shows a flow chart describing a possible embodiment of how data from the environmental detector 1401 may be converted into a graphic. The data may be collected by the environmental detector 1401. The data may then be transferred through a software API 1402 for data analysis 1403. Data analysis 1403 may include characterizing air quality and determining if the sensor data represents good, tolerable, or bad air quality. Data analysis 1403 may further include generating a trend line for prediction of future conditions. After analysis the data may be illustrated graphically on an electronic device 1404 by a software API 1403. In addition to or instead of a graphical illustration of the air quality assessment, an illustration of an animal mascot may also be provided on the electronic device. The animal mascot may be illustrated with a mood indicating the air quality assessment outcome, for example, the mascot may smile for good air quality and frown for bad air quality. In an example, the animal mascot may be a bird.

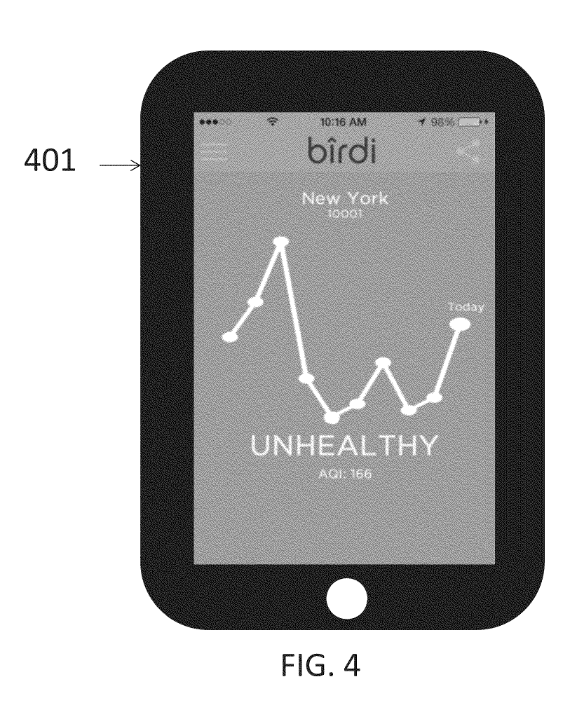

An example of a graph that may be generated by an environmental detector is shown in FIG. 4. The environmental detector may generate a graphed time history of sensors measurements for a specified time period, for example, the fixed time period may be at least 1 min, 30 min, 1 hour, 3 hours, 6 hours, 12 hours, or 1 day. The graphs may depict sensor data from the gas and particle sensors, the data may be a measurement rather than a binary yes or no detection event. The graph may correspond to data collected over a specified time period. A user may interact with the detector to inform the detector of preferred or comfortable air quality conditions based on collected data. The graphs may be generated with a regular periodicity and sent a user's electronic device, alternatively the graphs may be sent on demand to a user's electronic device when a user requests a graphical summary of air quality measurements. The graph may be transmitted to a user's electronic device directly from the environmental detector or it may be sent from the server off board the detector. A user may submit a request to the server from their electronic device for a graph of the sensor measurements from a specified timer period. A user may choose to receive a graph of all sensor measurements or a graph of only a selection of one or more sensor measurements. A user may adjust the settings corresponding to the content and frequency of the graphed measurements from their electronic device. The graphs may be a time history of measurements from the sensors, one or more sensor measurements may be shown on the same graph. The graph may also provide a regression attempting to predict future sensor measurements. Additionally, a graphic showing a map of air quality conditions may be generated based on data from environmental detectors in homes or buildings in alternate locations. A user may choose to release air space characterization data to a social media network to inform other of the current or historical ambient air quality.

The user interface of the electronic device may be configured to monitor the function of the sensors and the batteries on board the environmental detector. The battery health and charge may be displayed to a user through the user interface on the electronic device on demand. The battery may be in connection with a voltage sensor. The voltage sensor may monitor the voltage of the battery which may correlate with the battery's charge state. The voltage sensor may detect when the battery is low on charge and may communicate with a user through the user interface. Low charge on the battery may prompt a user to make a reminder to charge the battery or to order a replacement battery, the prompt may be communicated to a user through a phone call, text message, email, social media alert, or some combination of the listed alert mechanisms. Alternatively the user may allow the battery to be ordered automatically. Similarly, in an embodiment in which the battery is charged by moving the environmental detector to a charging station a full charge on the battery read by the voltage sensor may prompt a user to remove the device from a charging station.

The environmental detector may perform various power management techniques to increase the battery life. One technique may be that the detector may memorize a WiFi AP connection detail from the last access and limit IEEE 802.11 module on time by sending authorization packets without scanning every time. Another technique may be to pulse sensors.

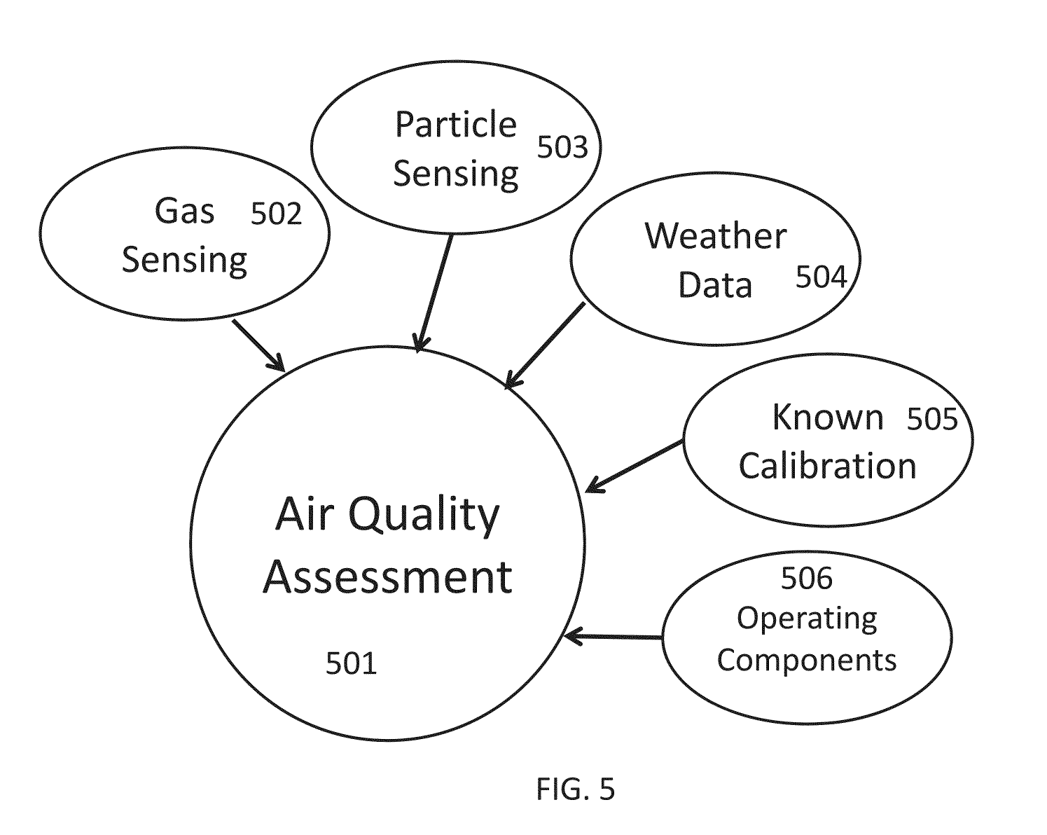

The environmental detector may be configured to conduct an air quality assessment. An air quality assessment may be based on measurements from a set of sensors onboard an environmental detector. The air quality assessment may be performed by the processor on board the environmental detector or the assessment may be performed at the server off board the environmental detector. The detector may have separate microprocessors for detection of smoke, carbon monoxide, and other air quality measurements. The separate microprocessors may increase reliability. The inputs to the air quality assessment are shown in the graphic in FIG. 5. Inputs to the air quality assessment 501 may be measurements of the concentration of gaseous species 502. The gaseous species may be detected by gas sensors. Another input to the air quality assessment may be particle detection 503. Particle measurements may describe a number of particles in a volume and the size range of the measured particles. A combination of gas measurements (e.g carbon dioxide) and particle measurements (e.g. pet dandruff) may be configured to detect animals living in or approaching a space. The environmental detector may alert a user or automatically communicate with connected fans and/or filters to mitigate pet dandruff. In addition to the measurements from on board sensors a detector may further include information regarding the season, daytime, local weather 504, and a known calibration when interpreting the air quality 505. A known calibration may come from a database accessed by the detector via the internet, for example a seasonal temperature and humidity average. Otherwise, a known calibration may come from historical baseline measurements performed by the environmental detector and stored on the storage device on board the detector or on the server. In a third case, the known calibration may be defined by the user through the user interface software on an electronic device. In an example, a known calibration may refer to a base line expected condition in an environment, for example, a basement based on information from a database, historical measurement, or a user input. Based on the known calibration in the example, a sensor in a basement may experience higher levels of moisture detection than a sensor in an above ground environment. Another input into an air quality assessment may be operation of other components 506. Other components may be mechanisms or appliances configured to influence ambient air quality in communication with an environmental detector. In an example other components configured to influence ambient air quality may be windows, fans, air purifier systems, air conditioning units, and ventilation ducts. These components may be configured to communicate to an environmental detector their operating state (e.g. open versus closed or on versus off).

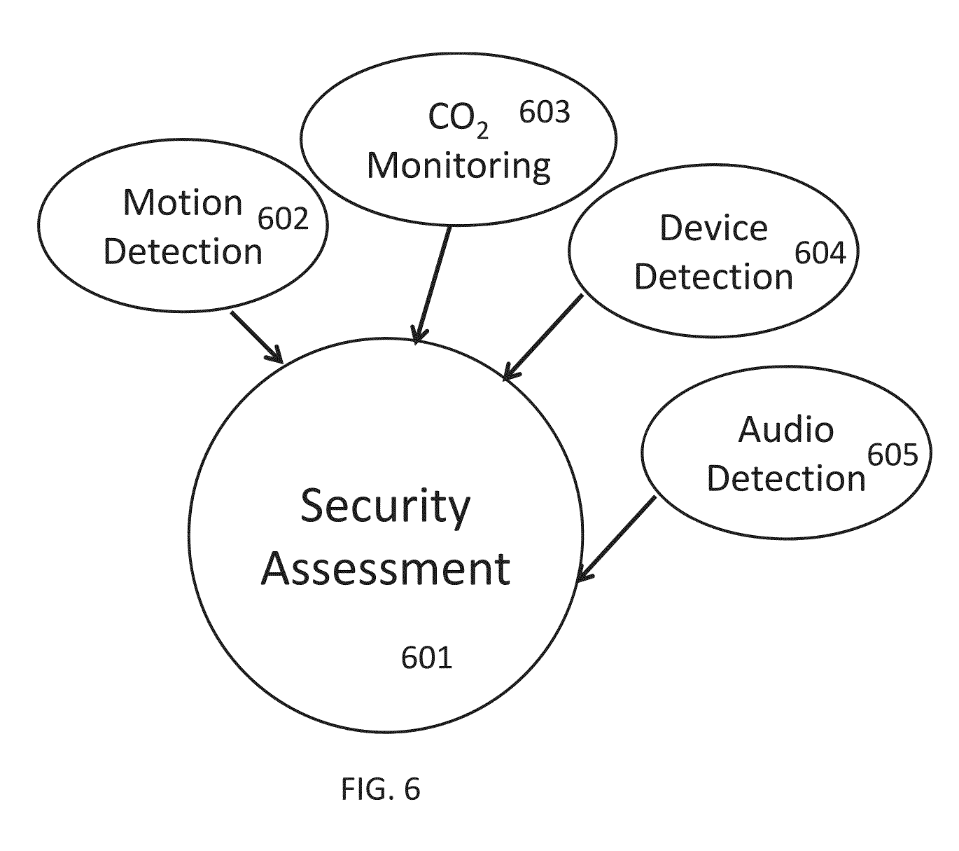

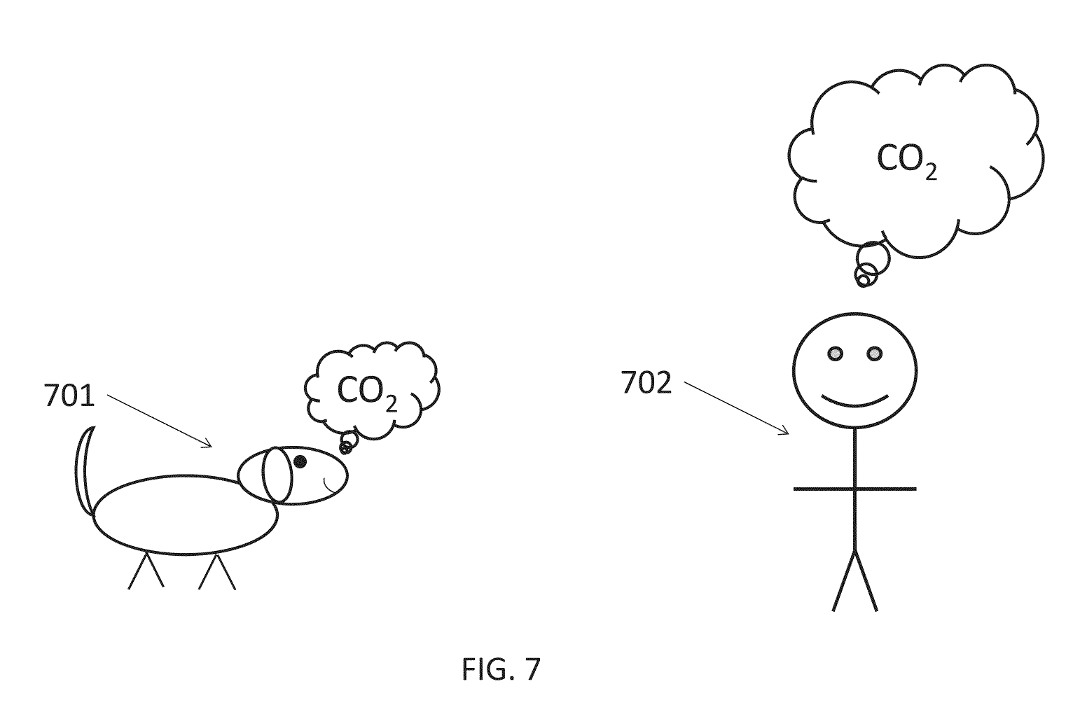

The environmental detector may be configured to conduct a security assessment. A security assessment may be based on measurements from a set of sensors onboard an environmental detector. The inputs to the security assessment 601 are shown in the graphic in FIG. 6. The environmental detector may comprise a motion detector and/or a PIR sensor. Alternatively, the Bluetooth or WiFi sensor may be configured to detect motion. The motion detector and/or PIR sensor may detect movement in an environment 602. The environmental detector may also include a CO₂ sensor 603. The CO₂ sensor may be one of the gas sensors described for use in conducting an air quality assessment in FIG. 5. The CO₂ sensor may be a MEMS-based spectrometric sensor. Measurement of the CO₂ levels may further inform the environmental detector the probability of an intruder. The CO₂ emissions of a human, animal, or group of humans may be distinguishable. In an example shown in FIG. 7, the combined sensory information from the motion and CO₂ sensor may be combined to eliminate a false threat such as a dog 701 walking through a house versus a burglar 702. The motion detector may not be capable of distinguishing the motion of the dog and the motion of the burglar. Combining the CO₂ emissions of the detected moving objects may distinguish the moving object as a dog or a burglar by a known difference in CO2 emission between a dog 701 and a burglar (e.g. human) 702. The security assessment may also consider detection of wireless devices. The environmental detector may be configured to identify wireless devices in the vicinity of the detector by emitted wireless, WiFi, or RF signals from the device. The environmental detector may be configured to identify the device of a home owner from a foreign wireless device 604. The environmental detector may further comprise an audio sensor which may provide input information to a security assessment.

In another embodiment the motion and CO₂ sensor may be configured to monitor persons that are older adults, unhealthy persons, and/or infants. The motion detector and CO₂ sensor may be combined to monitor movement and breathing of said persons with known or suspected medical conditions. If the motion and CO₂ detector indicate that the person has stopped breathing and/or stopped moving an alert may be sent to a family, coworker, friend, neighbor, or medical professional. The detector can serve as a proxy for spirometry data, a test that helps with the diagnosis of certain lung conditions by measuring the amount or speed of air a person a person inhales or exhales

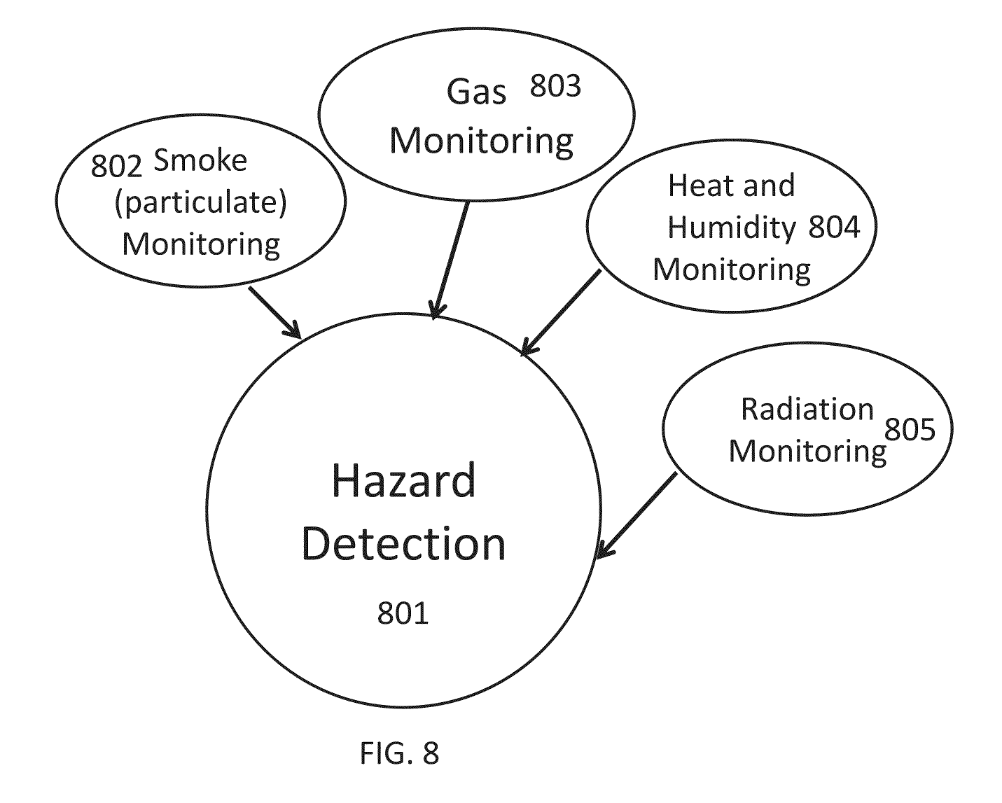

The environmental detector may be configured to detect a hazard. A hazard detection may be based on measurements from a set of sensors onboard an environmental detector. The inputs to the hazard detection are shown in the graphic in FIG. 8. One input to the hazard detection 801 may be particulate measurements 802. For example, smoke may be detected by the particulate measuring sensors during a fire. Information from the particulate and gas sensors may be combined to characterize the severity and the composition of a detected smoke emission. For example, the thickness of the smoke may indicate the severity of a detected smoke emission. Additionally, the gas species detected by the gas sensors may be used to characterize the strength of a fire and the type of material that is burning. The particulate sensor may be configured to distinguish between smoke from a fire and smoke from a cigarette. In an example, the environmental detector may distinguish from cigarette smoke and fire smoke in order to determine if the detected smoke is indicative of a hazard. The detection of cigarette smoke may be recorded and an alert may be sent to a building owner or manager. A building owner or manager may be a landlord or hotel manager that may prohibit smoking in their facility. Additionally carbon monoxide (CO) measurements may be provided from the gas sensors 803. A combination of CO, smoke, and/or heat may indicate a high probability that a fire is being detected. Additionally detection of CO₂ by the environmental detector may be an input indicating high probability of a fire. Detection of low humidity may further provide evidence to the detector that the probability of a fire condition is high. Hazard detection may further include inputs from temperature and humidity sensors 804 onboard the environmental detector. An additional input for hazard detection may be an atomic radiation sensor 805. The atomic radiation sensor may detect unsafe levels of radiation. The plurality of sensors on board the environmental detector may be combined to eliminate detection of false hazards. The air composition measured by the sensors on board the environmental detector may be considered when detecting a hazard, for example aged smoke from a nearby wildfire may result in a different gas and particle detection footprint compared to smoke from an oven fire inside of a space being monitored by an environmental detector. The environmental detector may confirm a nearby wildfire using information obtained from the internet or from other connected environmental detectors. Similarly, a large particulate detection by the environmental detector may indicate a nearby tornado. An earthquake may be detected by an inertial sensor in the detector. In another example, the environmental detector may be able to detect differences in smoke coming from a cigarette versus smoke coming from a house fire. In a case in which a mesh of detectors are installed throughout a building or house the mesh of detectors may communicate with each other to detect spreading of a hazard, for example, smoke and elevated temperature may be detected by a first detector and then detected by a second detector after a time lapse to indicate spreading of a hazard.

The environmental detector may be configured to combine measurements from a temperature, humidity, particle, and gas sensor information to characterize a fire event. For example the rate of heat spread may be determined by the temperature readings on adjacent environmental detectors. A size and composition of smoke particulates determined by the particle sensor may indicate the type of fire (e.g. smoldering or flaming) and may be combined with measurements from the gas sensors to determine what is burning. Further, the carbon monoxide and carbon dioxide quantities measured by the respective gas sensors may provide additional insight in to the type of fire detected. In an example, the oxygen availability, or ventilation of a fire may be indicated by the CO and or CO₂ measurements by the environmental detector. In some cases the ratio of CO₂ to CO may indicate that the fire's access to oxygen. A poorly ventilated fire may produce more CO relative to CO₂ compared to a well-ventilated fire. The fire characterization may be stored and provided to a service agency during or after occurrence of the fire.

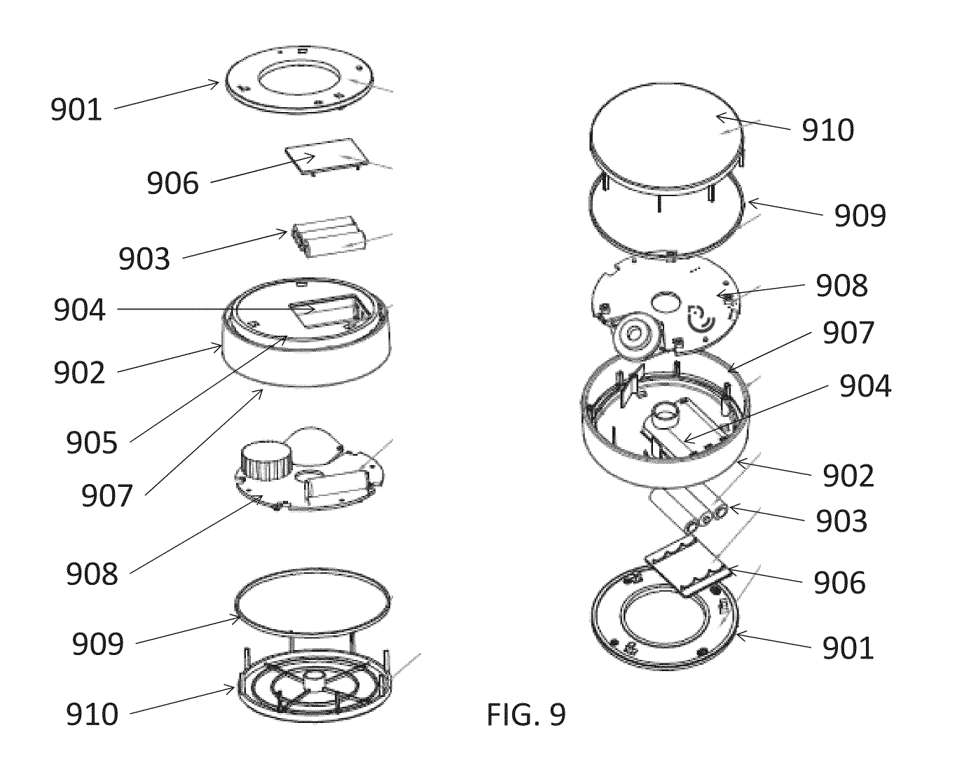

FIG. 9 shows an exploded view of the environmental detector. The environmental detector may attach to a surface, for example a wall or ceiling, by a mounting ring 901. Alternatively, the environmental detector may be compatible with an existing mounting ring or hardware component from another previously mounted device (e.g. smoke or carbon monoxide detector). The body 902 of the environmental detector may removably attach to the mounting ring 901 by a hardware component such as a screw or mounting tape. Alternatively, the body 902 of the environmental detector may removably attach to the mounting ring 901 by a snap or sliding connection. The body may be configured to house one or more batteries 903. The batteries may be housed in the body of the environmental detector in a recessed region 904 on the top side 905 of the environmental detector. The recessed region 904 may be molded into the body 902 of the environmental detector. The batteries 903 may be rechargeable or disposable batteries. In an alternative embodiment, the environmental detector may not have batteries. In this case, the environmental detector may be configured to connect to a power supply directly through a wired or wireless connection. The power supply may be accessed through wired connection in a wall or ceiling. The device may comprise a backup battery in addition to a connection to the power supply. In the case of a power outage, the device may alert the user of the power outage using the backup battery. The batteries 903 may be enclosed in the recessed 904 region by a removable door 906. The removable door 906 may be connected to the body of the environmental detector by a hinged, sliding, or fitted connection. The removable door 906 may be affixed to the body of the environmental detector by a screw, snap, or Velcro connection. The removable door may be configured such that it may not close unless batteries are installed in the recessed region 904. The bottom side 907 of the environmental detector body may be configured to house one or more sensors, one or more processors, and electrical components. The detector may comprise one processor to control all of the gas and particle sensors or a plurality of processors, each one dedicated to a specific sensor. The sensors, processors, and electrical components may be connected to a printed circuit board assembly (PCBA) 908 fitted in the body of the environmental detector. A light ring 909 may surround the outer perimeter of the bottom of the body of the environmental detector. The light ring may be rotated about the environmental detector body 902. Rotation of the light ring may correspond to an analog input to the environmental detector. The light ring 909 may be observable by a user in a room or space with an installed environmental detector. The light ring 909 may be in electrical communication with the PCBA 908 inside of the body of the environmental detector. The light ring 909 may contain colored LED lights. The bottom 907 of the body of the environmental detector may be sealed with a switch cover 910. The switch cover 910 may comprise inlets for air to be sampled by the sensors inside the body of the environmental detector.

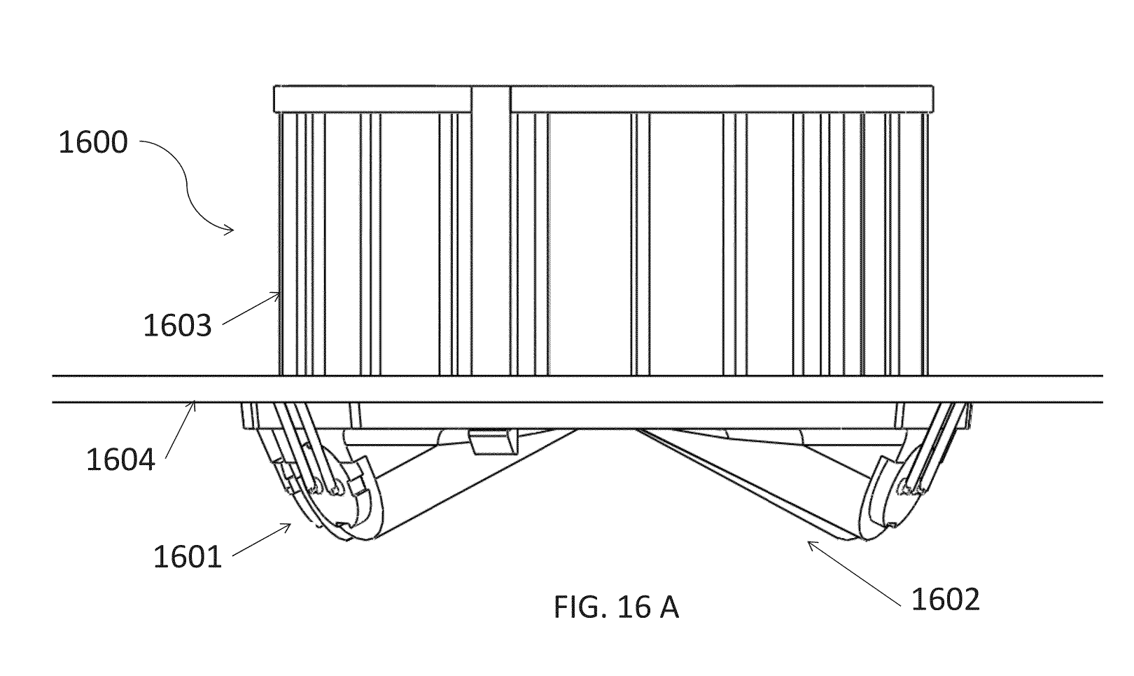

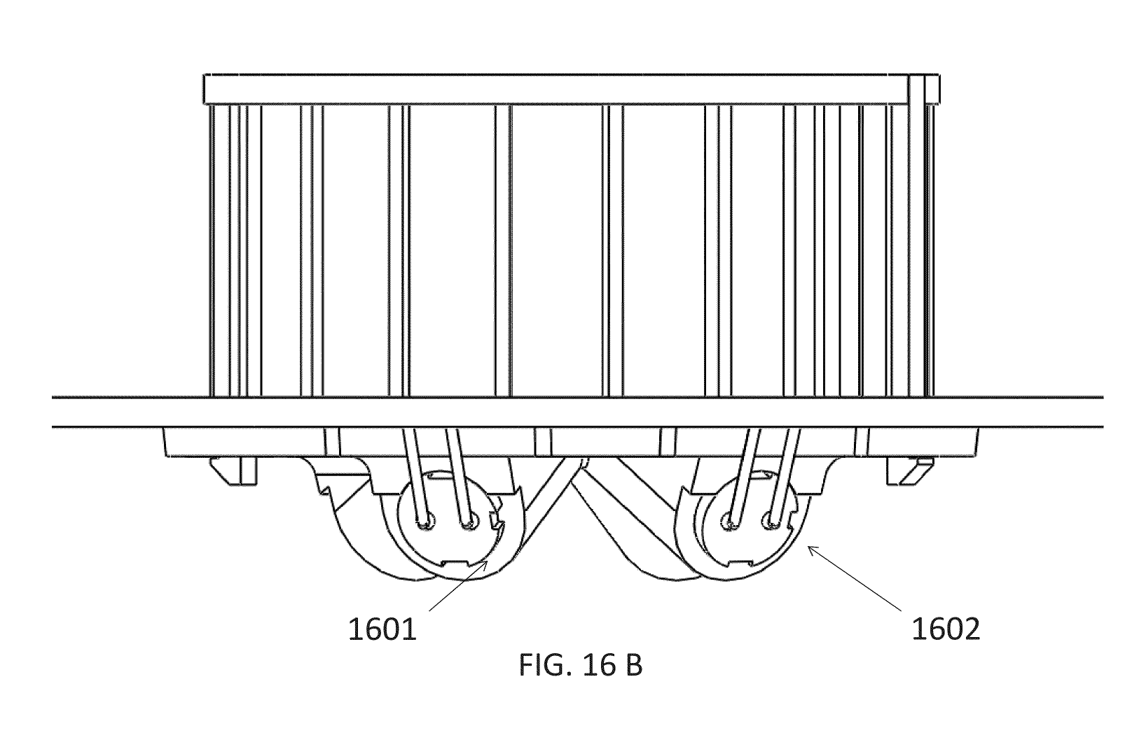

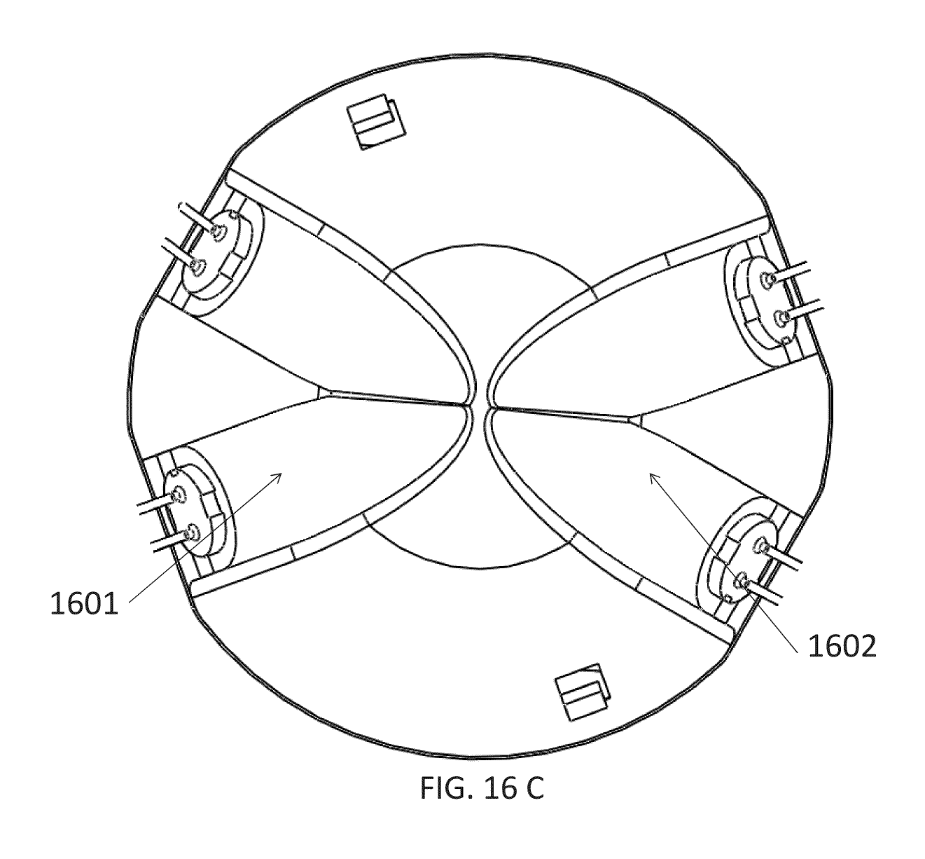

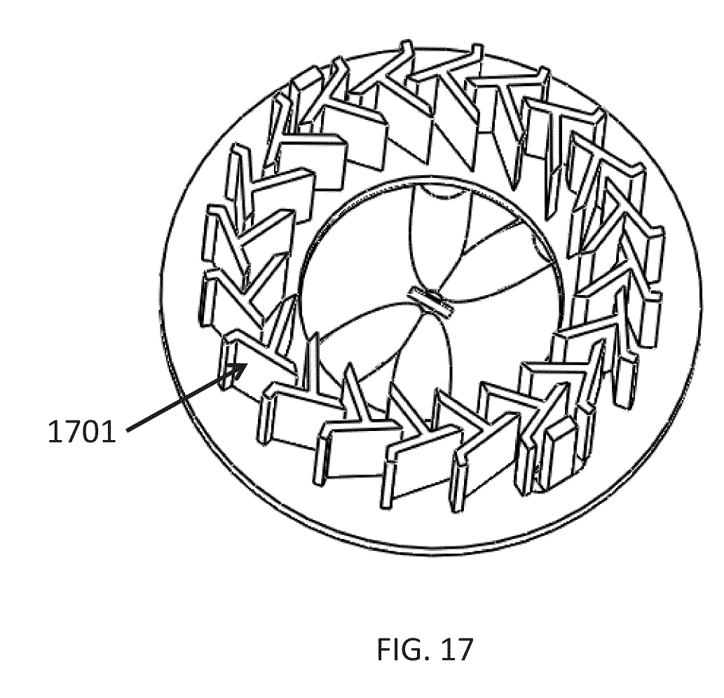

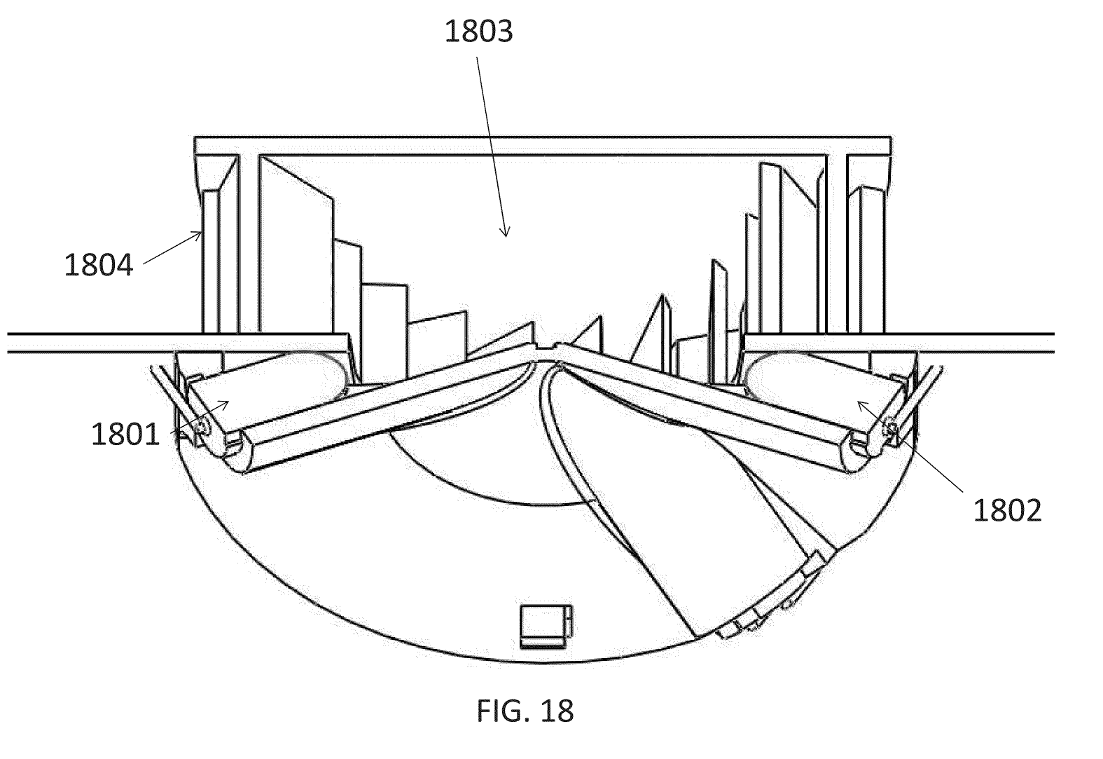

The body or housing of the environmental detector may house sensors configured to monitor the composition of the air in the space surrounding the environmental detector. One such sensor may be a particle detector. The particle detector may be housed in a detection chamber inside of the environmental detector. A front, side, and underside view of the particle detector housing are shown in FIG. 16 A, FIG. 16 B, and FIG. 16 C respectively. One or more light source cavities 1601 and one or more photodetector cavities 1602 may be present in the particle detection housing 1600. The light sources and/or photodetectors may be resting on or connected to the PCBA 1604. The detection housing may be configured such that air may enter the detection housing while light may not enter from the ambient environment. The entrance of ambient air into the detector without allowing ambient light into the detector may be achieved by air baffles 1603. A detailed view of possible air baffles that may be part of the particle detection sensor are shown in FIG. 17. A cross-sectional view of a possible embodiment of the particle detector is shown in FIG. 18. The cross-sectional view shows a cavity for a light source 1801 and a cavity for a photodetector 1802. The particle detector may comprise one or more cavities for light sources and photodetectors. The cross-sectional view also shows a chamber in which particles may be detected 1803. The particles may be detected in ambient air which may enter the chamber 1803 through the baffles 1804.

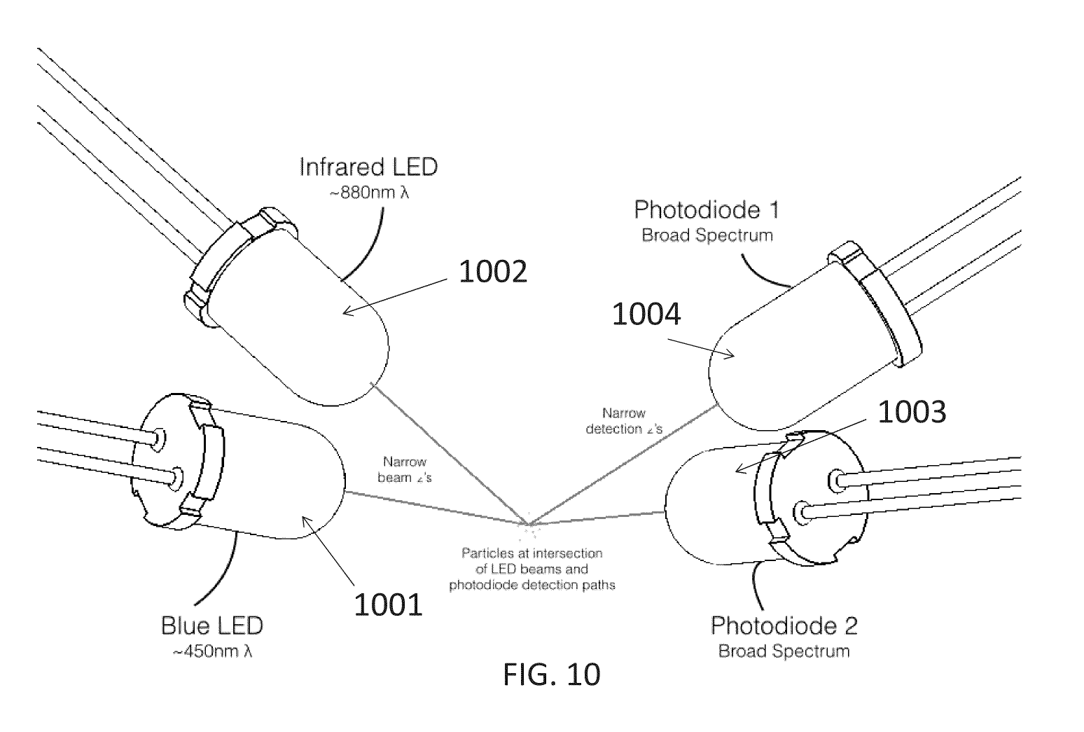

An example showing a possible embodiment of the particle detector components is shown in FIG. 10. The particle detector may comprise a light source. The light source may be and LED (light-emitting diode). The light source may be housed in a detection chamber with one or more photodetectors. The particle detector may be configured to measure a wide range of particle sizes. The particle detector may be configured to detect particles in the PM 2.5 range (e.g. particles with a diameter of less than 2.5 μm) and/or the PM 10 range (e.g. particles with a diameter of less than 2.5 μm).

In an example, the particle detector may comprise a first 1001 and second 1002 light source. The first light 1001 source may emit light at a relatively lower wavelength than the second light source. The magnitude of the wavelength of light emitted by the first light 1001 source may be roughly half the magnitude of the wavelength of light emitted by the second light source 1002. In an example, the first light 1001 source may emit blue light. The blue light emitted by the first light source 1001 may have a wavelength in the range of 400 nm to 500 nm. The second light source 1002 may emit infrared light. The wavelength of the second light source 1002 may be in the range of 800 nm to 1 μm. In a preferred embodiment the first light source 1001 may emit blue light with a wavelength around 450 nm and the second light source 1002 may emit infrared light with a wavelength of about 880 nm.

Particles may enter the detection chamber in the environmental detector through air inlets and may travel through a light path of the first and second light source. The particle inlet may allow ambient air to enter but may be configured to prevent ambient light from entering the detection chamber. The particles may cause the light to scatter. The scattering angle of the light off of the particles may be detected by one or more photodetectors 1003, 1004. The photodetectors 1003, 1004 may be positioned relative to the first and second light sources such that the photodetectors 1003, 1004 may capture only light emitted from particle scattering and may not detect light directly emitted by the first and second light sources. The photodetectors 1003, 1004 may be photodiodes. Particles of different sizes may scatter different wavelengths of light with different efficiencies. Relatively smaller particles may be more efficient at scattering light at relatively smaller wavelengths. For example, blue light may be more efficient at scattering particles with a diameter below 2.5 μm compared to infrared light. The first and second light source with different wavelengths may be configured to scatter small and large particles efficiently.

The photodiodes may be placed at two different angles such that they may be configured to detect light scattering from the particles at two different angles. The size, molecular weight and color of a particle may be related to its scattering angle and intensity of incident light. The scattering angle and intensity may be a function of both the wavelength of the incident light and the incoming angle of the incident light. Relative properties of particles may be inferred from differences in scattering efficiency or scattering angle of light off of the particle. The inclusion of a first and second light source and a first and second scattering angle may result in a full characterization of particle size and composition such that particles from different sources can be distinguished from each other.

The particle detection sensor may be configured to detect particles such as pollen, dust, water droplets (water vapor), soot, cigarette smoke, dust mites, mold, bugs, pet dander, and/or fire smoke. The particles may be airborne. The particles may have a longest dimension in the range of 0.001 μm to 10 μm. The particle detector may record measurements of particle detection at discrete intervals and may generate a continuous data stream of measurements of the detection events. The data stream may be stored on the storage device on board the environmental detector. The particle detection sensor may detect a particle event which may refer to detection of a particle of a given size, molecular weight and color. The particle detection sensor may communicate incidence of a particle detection event to the processor. The processor may be on board or off board the environmental detector. The processor may monitor the particle detection events and may alarm a user in the event of a high frequency of particle detection events which may correlate with detection of a hazard or an adverse air quality condition.

The environmental detector may have one or more on board gas sensors. The on board gas sensors may be housed in the body of the environmental detector. The on board gas sensors may be electrochemical sensors or metal oxide semiconductors. The on board gas sensors may be configured to detect the concentration level of a gaseous species of interest, for example, nitrogen oxides (NOₓ), carbon monoxide (CO), sulfur oxides (SO_{X}), Ozone (O₃), and/or volatile organic hydrocarbons (VOC's). The environmental detector may further include a carbon dioxide (CO₂) sensor. The CO₂ sensor may have the dual purpose of contributing to an air quality assessment as well as an input to detection of humans and other animals. The CO₂ sensor may be a MEMS-based spectrometric sensor. The gas sensors may record measurements of gas concentration at discrete intervals and may generate a continuous data stream of measurements of the concentrations. The data stream may be stored on the storage device on board the environmental detector.

In addition to gas and particles detectors the environmental detector may further include a temperature sensor and a humidity sensor. The temperature and humidity sensor may provide additional monitoring of the air space in the environment of the detector. In an example temperature data may be combined with gas and particulate data to detect a fire condition. The temperature and humidity sensor may also provide information to aid in interpretation of the results detected by the particulate and gas sensors. In an example a particulate sensor may detect a large number of particles in the size and molecular weight range of water droplets, the humidity detector may provide additional information to confirm or reject the determination that the detected particles are water droplets.

The environmental detector may further comprise an audio sensor and a microphone. The audio sensor may be configured to detect noise levels across a broad range of frequencies. The audio sensor may be a speaker or a microphone. The audio sensor may be on board the environmental detector and/or the audio sensor may be a separate sensor in communication with the environmental detector. The audio sensor may be configured to determine noise from human movement, operating machinery, animal movement, human voices, and other acoustic disturbances. The audio sensor may be able to alert a user in an environment when the sensor detects audio above a threshold decibel level such that it may be harmful to a user. The environmental detector may also have a microphone, the microphone may be used to communicate with a user. The audio sensor may be configured to transmit encoded data through audio steganography and/or frequency-shift keying and may also send encoded data through a speaker on board the environmental detector.

The environmental detector may include locating sensors. Locating sensors may determine the location of the environmental detector. A location sensor may be GPS. In another example an accelerometer may be a location sensor. The location sensor may define a radius surrounding the environmental detector. Electronic devices in the defined radius may receive information about the environmental detector in an application or software interface installed on the electronic device. In an alternate embodiment, the environmental detector may not include a locating sensor, instead the environmental detector may be programmed with a known location at the time of installation of the detector.

A user may program an environmental detector with a specific type of location in a space with the environmental detector installed. The environmental detector may be aware of its geographic and spatial location through a locating sensor. Alternatively, the environmental detector may be aware of its geographic and spatial location through combined information from a locating sensor and a downloaded or otherwise available building map (e.g. blue print). The environmental detector may use information from a building map to understand spatial location and features of adjacent spaces (rooms). In an example, an environmental detector may read a blue print to determine the location of the detector relative to building features such as windows, air ducts, electrical components, and plumbing components. The blue print may also provide room geometry, for example ceiling height. The blue print may provide building history. Additional information regarding a location may be provided by a user. In an example the user may provide the environmental detector with information regarding space usage in the location of the installation of the environmental detector. For example, the user may inform the environmental detector that it is installed in a bedroom, kitchen, living room, chemical storage facility, basement, or another type of room.

The environmental detector may collect a reading from any combination of the gas, particle, humidity, temperature, and wireless Bluetooth sensors at discrete time intervals to characterize and air space surrounding the detector. The discrete time interval may be in the range of 0.01 milliseconds to 24 hours. The discrete time interval may be fixed or it may vary over time. The discrete time interval may vary automatically such that they may change according to a seasonal or daily schedule. For example, readings may be more frequent during summer months when air quality conditions are frequently impacted by increased ambient temperature. In another example, readings may be more frequent during rush hour time periods (e.g. 7 am-9 am and 5 pm-7 pm) when automobile pollution is expected to temporarily diminish air quality near congested roadways. To save battery reading frequency may decrease when a user is not present in an environment. A user may control the frequency of readings. Readings may be controlled by a user interface on a device in communication with the environmental detector, for example, a computer or a smart phone.

The reading may be stored on the storage device on board the environmental detector, additionally the reading may be sent to the server located off board the detector. The reading may also be communicated to the processor onboard the detector for use in space monitoring analysis. Abnormalities in one or more sensor readings may trigger an alarm by the environmental detector. An abnormality may be a detection of a gas or particle above a specified threshold. The specified threshold may be a concentration in the case of a gaseous species, or a number density or obscuration percentage in the case of particle species. Alternatively an abnormality may be a spike in a particle or gas detection. In an example a spike of at least 50%, 60%, 70%, 80%, 90%, 100%, 200%, 300%, 400%, or 500% in the concentration of a gaseous species relative to an expected baseline value, or a number density or obscuration percentage of a particle species may represent an abnormality. Detection of an abnormality may indicate detection of a hazard.

In the case of an abnormality the environmental detector may initiate an alarm. An alarm may be an audio or a visual signal. The alarm state may be dynamic and reactive to user input, for example, an alarm state may change in response to confirmation or denial by a user that a hazard is occurring. The environmental detector may have a full spectrum RGB indicator light and may connect to other smart lighting devices. The environmental detector may connect to smart lighting devices to operate a timed lighting sequence when a user is out of town to give the impression that the user is home. The environmental detector may communicate with the mesh of environmental detectors to tailor a response to a specific situation. A first environmental detector may detect an abnormality and a second environmental detector may detect presence of a user (through CO2 detection, motion detection, or cell phone signal detection, or a combination of these detection signals). The first environmental detector may cause an alarm response in the environment surrounding the second detector to get the attention of a user as well as in the location of the environment surrounding the first detector where an abnormality has been detected. In an example, if a fire is detected in a kitchen and a user is detected in a bedroom an alarm may sound in both the kitchen and the bedroom. Additionally, the environmental detector may communicate with connected electronic devices to alert a user. The environmental detector may communicate with a user by displaying a visual and/or audio signal through the connected electronic device through a screen display, microphone, and/or speaker component. The communication signal from the environmental detector may interrupt the regular function of the electronic device. In an example, the environmental detector may communicate a detected hazard through a visual display by interrupting a television program, video game, or cellular telephone call.

A visual signal on an environmental detector may be a change in color of the light ring surrounding the outer perimeter of the environmental detector. The environmental detector and a series of connected environmental detectors may light up and/or issue spoken directions to guide a user through a pre-planned escape route in the case of a detected hazard. In an example the environmental detector may be programmed a-priori with a preferred escape route for a fire. When a fire is detected the environmental detectors installed along the preferred escape route may illuminate to guide a user along the route. The lights may illuminate around the full circumference of the environmental detector. Alternatively, a group of lights may illuminate and give the appearance of traveling around the circumference of the detector by sequentially turning on the light adjacent to the front of the group and turning off the light at the end of the group. During a non-alarm condition (normal) the light ring may be green (or another color) or unlit. The detector light ring may illuminate to indicate a non-alarm condition only when a user is detected in the vicinity of the detector. The user may be detected in the vicinity of the detector though one or more sensors for example, the CO₂ sensor, Bluetooth connection, or a thermal sensor. When an abnormality is detected the light ring may change to yellow or red for a moderate and severe threat respectively. The lights may be illuminated continuously or the lights may flash or have a strobe light feature. The lights may be illuminated to communicate Morse code. Alternatively or in addition to light illumination Morse code can be communicated through the audio microphone.

The light ring may serve the dual purpose of indicating a detected hazard and also providing recreational lighting, or mood lighting, features in the absence of hazard detection. Mood lighting may be disco lights, lava lamp lights, one or more colored lights, or a light configured to imitate a candle glow. Other recreational lighting features may be alerts, for example, the environmental detector may be configured to provide recreational lighting in response to an important event. In an example, the recreational lighting may respond to information from a network (e.g. internet) regarding a score or an outcome of a sporting event. A specific example may be a run scored by a user's preferred baseball team, when a run is scored the environmental detector may illuminate the recreational lights in the color of the user's preferred team. Other forms of recreational lighting may include bouncing light, or display of multi colored lights (e.g. rainbow).

An audio alarm may be a noise disturbance or a spoken instruction from the environmental detector. The noise may be a high or low frequency pitch. In an example, the noise may be a 400 Hertz (Hz) and 520 Hz square wave T-3 sounds and 3100 Hz pure tone sounds. A tone may have a frequency of 520 (F1) Hz±10% with subsequent harmonic frequencies occurring at 1560 (F3), 2600 (F5), and 3640 (F7) Hz±10%, particularly as it adheres to legal standards such as those standards outlined by UL, NFPA, and similar international bodies. Some people may have hearing impairments that inhibit them from hearing tones in a specific frequency range, the environmental detector may be programmed to make a noise in a frequency range that can be heard by these hearing impaired people. An electronic device may emit a sound at one frequency while the environmental detector emits a sound at an alternate frequency to indicate an alarm. In the case of spoken instructions the detector may comprise voice recognition and understand language such that the user may respond to the detector verbally. A user may respond to the detector to hush an alarm or provide additional information about a detected hazard. Alternatively, the environmental detector may initiate an audio response from a connected electronic device, for example a cell phone alarm tone may be played in response to detection of an abnormality by the environmental detector. The electronic device may vibrate in response to detection of an abnormality by the environmental detector in addition to or instead of playing a tone. A user may choose the response mechanism, for example a user may choose to receive a vibration rather than an audio alert. Alternatively, the electronic device may alert a user of a notification from the environmental detector using a user's normal device settings.

Hazard detection by an environmental detector may be communicated to the server directly by the environmental detector or indirectly from an electronic device in communication with the environmental detector. In response to a hazard detection the server may notify one or more users. The environmental detector may notify a user through their electronic device running the environmental detector software. The server in communication with the environmental detector may broadcast a detection or characterization event. The software may allow the user to manage the alert and may facilitate a conversation between multiple receivers of the notification. A user may be the owner of an environmental detector that has detected a hazard. Additionally a user may be any other individual who may own an environmental detector and/or who may have downloaded or otherwise obtained the environmental detector user interface software on an electronic device. The additional users that can be notified by the server in response to a detected hazard may be controlled by an owner of an environmental detector. For example, an environmental detector owner may choose to have their spouse, child, neighbor, friend, or parent notified by the server when a hazard is detected by their environmental detector. Additional users that can be notified by the server in response to a detected hazard may also be chosen based on a geographic radius. These users may not be persons familiar to an owner of an environmental detector. The additional users may be anyone within the geographic radius with an electronic device configured to receive information from an environmental detector. The geographic radius may be an area surrounding an environmental defined by a user. The geographic radius may not be round and may not be symmetric around the location of the detector. The geographic radius may be a selected region. A user may specify the geographic radius in the settings feature of a software program in communication with the environmental detector. The radius may be specific to different types of detected hazards. For example, an environmental detector owner may choose to notify all persons in a fixed radius of their environmental detector when a hazard is detected. Notifications may be sent through existing push protocols such as the Apple Push Notification Services (APNS) of iOS devices or the Cloud to Device Messaging (C2DM) framework for Android devices. All persons in the radius may include all persons with the environmental detector user interface software installed on an electronic device, this may include owners of environmental detectors as well as a person who may not own a device but has downloaded the software to receive hazard alerts. A radius may refer to a geofence or other designated geographical area.

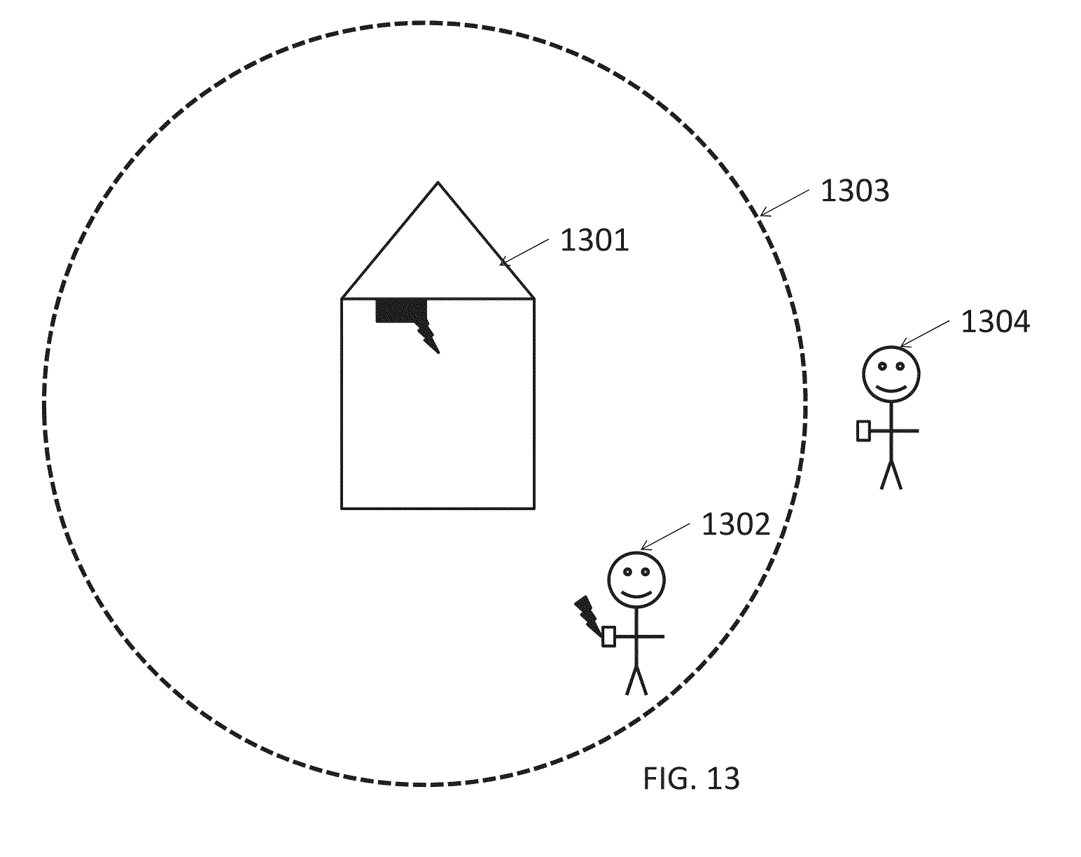

FIG. 13 shows an example of a possible radius to designate persons who may and may not receive a notification. In FIG. 13 home 1301 may have an environmental detector which has detected a hazard. Person 1302 may be inside the radius 1303 therefore they may receive a notification about the detected hazard. Person 1304 may be outside of the radius 1303 and may therefore not receive a notification.

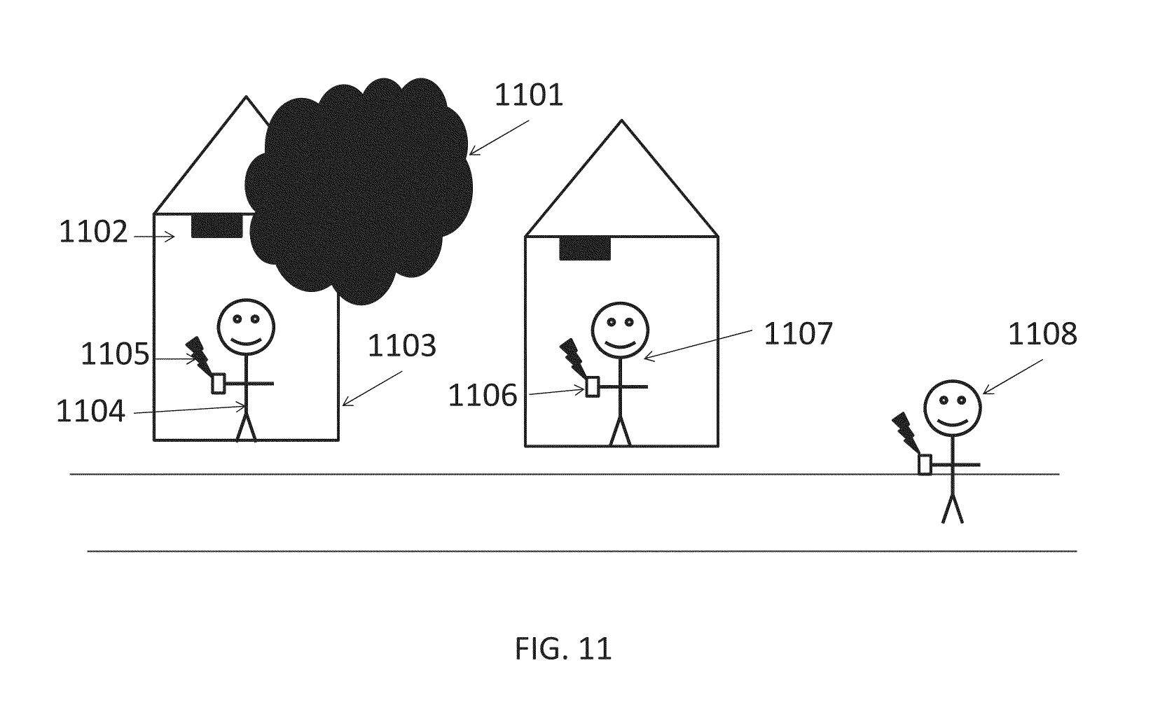

FIG. 11 shows an example of a detection of a hazard by an environmental detector and a subsequent response initiated by the server. In FIG. 11 a hazard, for example a fire 1101, may be detected by a first environmental detector 1102 in a home 1103 of a first user 1104. The first environmental detector 1102 may send an alert to a server indicating the detected hazard. In response the server may send an alert message 1105 to an electronic device belonging to a first user 1104. The server may also send an alert 1105 to a to an electronic device 1106 belonging to a nearby user 1107 that may also have an environmental detector installed in their home. The server may also send an alert to all users with the environmental detection interface downloaded on one or more electronic devices within a fixed geographic radius surrounding the first environmental detector which has detected a hazard. For example, the server may alert 1105 a user walking 1108 past the home in which a hazard has been detected. Notifying of users outside of a space of an environmental detector that has detected a hazard may create a community watch system such that neighbors, friends, and persons nearby a detected hazard can help to monitor and mitigate the detected hazard. An owner of a device may control who receives notifications from the environmental detector. The notification may include details of the hazard, or a characterization of an air space surrounding the detector, and options for a person receiving the notification to provide feedback, feedback may be confirming or denying the hazard. An owner may choose only to send notifications to a list of approved persons. Contact information from the approved persons may be synced with an address book stored on the electronic device, for example a contact list on a smart phone. A contact list may include a pre-configured set of home-dwellers who need to be notified immediately (first circle) as well as secondary set of neighbors & family (second circle). Contacts can also be taken from people already designated as “favorites” or “emergency contacts” in the phone. An owner may control the geographic radius in which users may receive notifications from the environmental detector. An owner may also configure the environmental detector to contact security and/or health professionals in the case of a detected hazard.

In another case the server may mitigate the detected hazard. For example, if the detected hazard is a poor air quality condition, which may be described as a detection of an amount of one or more species above a preset threshold, the server may send and alert to a user instructing them to eliminate the source of bad air quality (e.g. a chemical spill, improperly operating gas stove emitting CO, or furniture emitting volatile organic hydrocarbons (VOCs)). Additionally, the processor on board the environmental detector may be instructed by the server to communicate with other devices in a space or building where a hazard is detected to mitigate the hazard. The processor may turn on a fan or ventilation system or turn on an air purifier to mitigate the hazard. Alternatively or in addition to turning on a device to mitigate the detected hazard, a user may receive information through a call, text, email, or notification through the device software installed on an electronic device instructing them to mitigate the detected hazard. The information received may be an instruction to improve the air quality. In an example, the instruction may be to open or close a window, turn off an appliance, or re-orient a fan or air purifier.

In addition to the notifying at least one user in response to a detected abnormality the server may be configured to notify a government or private service organization when an alarm state is detected. The server may only notify a service organization after at least one user has confirmed that the detected abnormality is indicative of a hazard rather than a false alarm. The server may notify the service organization regardless of confirmation from a user if a user does not respond to a notification about an abnormality or if a user indicates that they are unsure of whether the abnormality is indicative of a hazard. The server may contact the service organization directly, for example through an API or channels including SMS or email, or the server may communicate with a electronic device through the software interface to give the user the option to contact a service organization. The server may know that location of the environmental detector and may be configured to contact the service organization to communicate data about the detected alarm state and the location of the alarm state. The server may further be in communication with network connected street lights and may instruct the street lights to flash in the vicinity of the space with the detected alarm state. The flashing street lights may aid an emergency response team in finding the space with the detected alarm state. The server may be configured to contact emergency and non-emergency services. The service organization contacted by the server may depend on the type of abnormality detected by the environmental detector. For example, when an environmental detector senses an abnormality indicating a fire condition the server may contact emergency services through a 911 or 112 call. The server may contact the emergency services directly or the server may alert a call center to make the call to emergency services. Alternatively, the server may also be configured to contact a non-emergency agency to make a “call for service”, in an example, a call for service may be a call to repair a gas or water leak. In cases where an environmental detector senses and abnormality indicating a leak condition the server may contact a non-emergency service through a 311 call. A 311 call may be made in response to detection of graffiti, a pothole, or street cleaning. The server may contact the service though a protocol interface, the alarm information may be transferred via JSON, XML, and/or CSV types. Similarly 911 may be contacted through a protocol interface, the alarm information may be transferred via JSON, XML, and/or CSV types. Information may be transferred back and forth between the server and the service organization. Information may include details about the detected abnormality, location of the detected abnormality, and/or other preset information.

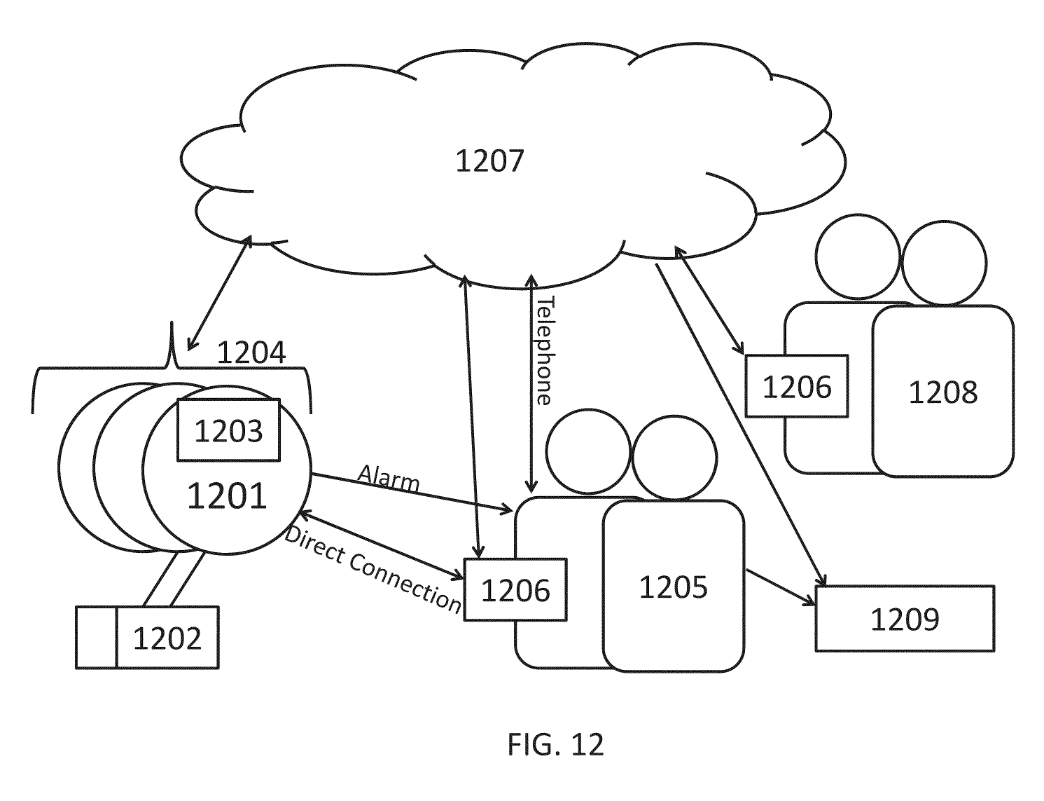

A graphic of a possible embodiment of the overall system architecture is shown in FIG. 12. One or more environmental detectors 1201 may be in communication with each other and also in communication with other sensory devices 1202. The connected environmental detectors and other sensory devices may form a mesh 1204. The environmental detectors 1201 may comprise a plurality of sensors 1203. The mesh may be in communication with responders or users 1205 through both physical alarms and direct connection to a software application on an electronic device 1206. The mesh 1204 may further communicate with a server 1207 through a mobile communication system or CDMA/GSM handling server, a WiFi router, Bluetooth, RF, or an internet connected smart device. The server 1207 may comprise connections to the server data base, telephony servers, push servers, and service authority servers. The server may communicate with the responders or users 1205 through a telephone or through a software application on an electronic device 1206. The server 1207 may also communicate with nearby persons 1208 through a software application on an electronic device 1206. The server 1207 may also communicate with emergency or non-emergency services 1209. The users or responders may also communicate with emergency or non-emergency services 1209.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. An environmental detector for monitoring an environment, said environmental detector comprising:
a particle detector, wherein the particle detector comprises a first light source and a second light source, a first photodetector, and a second photodetector, wherein the first photodetector and the second photodetector are configured to sense light scattered from a particle at a first scattering angle and a second scattering angle; and
one or more sensors configured to monitor an environmental condition.

2. The environmental detector of claim 1, wherein the first light source emits light with a wavelength in the range of 400 nm to 500 nm.

3. The environmental detector of claim 1, wherein the second light source emits light with a wavelength in the range of 800 nm to 1 μm.

4. The environmental detector of claim 1, wherein the environmental condition is air composition in the environment, humidity, or temperature.

5. The environmental detector of claim 1, wherein the first scattering angle and the second scattering angle are different.

6. The environmental detector of claim 1, wherein particle detector is configured to detect smoke, dust, pollen, soot, water vapor, and particulate matter with a diameter below 10 micrometers.

7. An environmental detector for monitoring an environment, said environmental detector comprising;
a plurality of sensors configured to monitor a concentration of species in an air space in the environment, wherein the plurality of sensors generate a continuous data stream comprising measurements of the concentrations of the species in the air space at discrete time intervals;
a memory unit configured to store the data stream generated by the sensors;
a processor configured to interpret the data stream to characterize the air space, and further configured to initiate an audio or visual response to the characterization of the air space; and
a transceiver configured to communicate with one or more electronic devices and a server off board the environmental detector, wherein the transceiver is further configured to communicate the air space characterization to the electronic devices and/or to the server at a discrete interval, wherein a user confirms or denies the air space characterization through the electronic device.

8. The environmental detector of claim 7, wherein the species are gaseous species and/or particles.

9. The environmental detector of claim 7, wherein the characterization the air space comprises a detection of a hazardous event, a change in air quality condition, and/or a security breach.

10. The environmental detector of claim 7, wherein a electronic device is a laptop, desktop, smart watch, smart glasses, tablet, or smartphone.

11. The environmental detector of claim 8, wherein the discrete time interval is in the range of 0.01 milliseconds to 24 hours.

12. The environmental detector of claim 7, wherein the audio or visual response to the characterization of the air space is a colored light.

13. The environmental detector of claim 7, wherein the audio or visual response to the characterization of the air space is spoken command.

14. The environmental detector of claim 7, wherein the audio or visual response to the characterization of the air space is terminated remotely by the electronic device.

15. An environmental detector for monitoring an environment, said environmental detector comprising;
a plurality of sensors configured to monitor a concentration of species in an air space in the environment, wherein the plurality of sensors generate a continuous data stream comprising measurements of the concentrations of the species in the air space at discrete time intervals;
a memory unit configured to store the data stream generated by the sensors; and
a transceiver configured to communicate with one or more electronic devices and a server off board the environmental detector, wherein the transceiver is further configured to communicate the air space characterization to the electronic devices and/or to the server at a discrete interval, wherein the server broadcasts the air space characterization to a group of users within a selected region.

16. The environmental detector of claim 15, wherein the group of users are within a geographic radius of the environmental detector.

17. The environmental detector of claim 15, wherein the group of users do not own an environmental detector.

18. The environmental detector of claim 15, wherein the species are gaseous species and/or particles.

19. The environmental detector of claim 15, wherein the characterization the air space may comprise a detection of a hazardous event, a change in air quality condition, and/or a security breach.

20. The environmental detector of claim 15, wherein a electronic device may be a laptop, desktop, smart watch, smart glasses, tablet, or smartphone.
